(19) United States
(12) Patent Application Publication
(10) Pub. No.: US 2021/0241184 A1
(43) Pub. Date: Aug. 5, 2021

(54) Method for Scheduling and Booking Aircraft Via Empty Leg Charter Flights

(71) Applicant: John Paul Beitler, III, Chicago, IL (US)

(72) Inventor: John Paul Beitler, III, Chicago, IL (US)

(21) Appl. No.: 16/777,042

(22) Filed: Jan. 30, 2020

(51) Int. Cl. G06Q 10/02; G06Q 10/10; G06Q 50/30; G06Q 30/06; G06Q 20/08; G06Q 30/08; G06F 16/2457; G06F 3/0482

(52) U.S. Cl. CPC G06Q 10/02; G06Q 10/10; G06Q 50/30; G06Q 30/0641; G06F 3/0482; G06Q 30/08; G06Q 30/0623; G06F 16/2457; G06Q 20/0855

(57) ABSTRACT

A method and apparatus related to the scheduling of private aircraft flights for the return portion of a one-way private charter flight. The method and apparatus utilize information uploaded into a database, such as departure airport, arrival airport, number of passengers and flight date, by an operator. A user may implement an application having an algorithm wherein the user may enter certain criteria into the application, such as selected criteria for departure airport arrival airport, number of passengers and flight date. The algorithm will compare the search criteria with the information in the database to determine a match for the selected criteria.

### FIELD OF THE INVENTION

The present invention relates generally to the scheduling of private aircraft flights. More particularly, the present invention pertains to booking the empty return portion of a booked one-way private charter flight.

### BACKGROUND OF THE INVENTION AND SUMMARY OF THE INVENTION

The present invention incorporates the booking and scheduling of the “empty-leg” portion of a chartered private aircraft flight. An “empty-leg” is the return portion of a one-way private charter flight. Typically, when a charter flight is scheduled using private aircraft, the aircraft must return to its home base or move to another airport to accommodate another scheduled flight. The empty-leg flight is when the aircraft is either returning to its home base or the aircraft is repositioning for the next scheduled customer, empty. Aircraft typically make the empty-leg flights without passengers and, thus, forgoes revenue potential. The empty-leg sector of the charter aircraft business does not have a reliable resource available to search and book empty-leg flights.

The present invention incorporates a method for scheduling and booking an empty-leg flight. The booking allows passengers to save money by paying for only the portion of the flight they fly. The flight would not be occupied by passengers if not for the booking, so the present invention attempts to monetize the empty-leg flight segment for the carrier aircraft operator. The current invention provides aircraft operators with the opportunity to earn extra income and revenue by selling the empty-leg portion of an aircraft's trip.

The present invention provides the benefit of allowing a user to search through a database of empty-leg charter flights and book private aircraft flights in real time. The invention utilizes a database of private aircraft operators throughout the United States. The invention could also be used for aircraft operations to and from destinations outside the United States.

Another aspect of the present invention coordinates empty-leg flight bookings by connecting the user directly to the aircraft operator of the empty-leg flight. A computer program operates to coordinate the aircraft operator and user in arranging the flight time, departure airport and destination airport. The computer program further matches the user with an aircraft and further provides for the pricing and payment for the flight.

These and other features and advantages of the present invention will be apparent from the detailed description, in connection with the appended claims.

### BRIEF DESCRIPTION OF THE DRAWINGS

The benefit and advantages of the present invention will become more readily apparent to these of ordinary skill in the relevant art after reviewing the following detailed description upon reference to the following drawings:

FIG. 1 is a flow-chart diagram of the present invention;

FIG. 2(A) is a diagram of the webpage from the present invention showing the criteria requested from a user;

FIG. 2(B) is a diagram of the various criteria in the “more” table of FIG. 2(A);

FIG. 3 is a diagram of a webpage from the present invention showing the list of flights matching the selected criteria of the user;

FIG. 4(A) is a diagram of a webpage from the present invention showing the selected flight summary;

FIG. 4(B) is a diagram of the aircraft details of the selected flight;

FIG. 5 is a diagram of a webpage from the present invention showing the information of the user;

FIG. 6 is a diagram of a webpage from the present invention showing the flight confirmation information.

### DETAILED DESCRIPTION OF THE PREFERRED EMBODIMENTS OF THE INVENTION

While the present invention may be encompassed by many embodiments and various forms, and will be described in the presently preferred embodiment and it should be understood that the present disclosure is to be considered an exemplification of the invention and is not intended to limit the invention to the specific embodiment illustrated.

It should be further understood that the title of this section of the specification, namely, “Detailed Description of the Preferred Embodiments of the Invention,” relates to a requirement of the United States Patent Office, and does not imply, nor should be read to limit the subject matter disclosed herein.

An empty-leg flight is an aircraft that is either returning to its home base or an aircraft reposting for its next customer—empty. Booking an empty-leg flight allows aircraft operations the opportunity to earn extra income on the empty leg portion of an aircraft's trip and allows passenger the opportunity to only pay for the portion of the flight they use the aircraft. The present invention utilizes a central locator on a computer control to find and book empty leg flights.

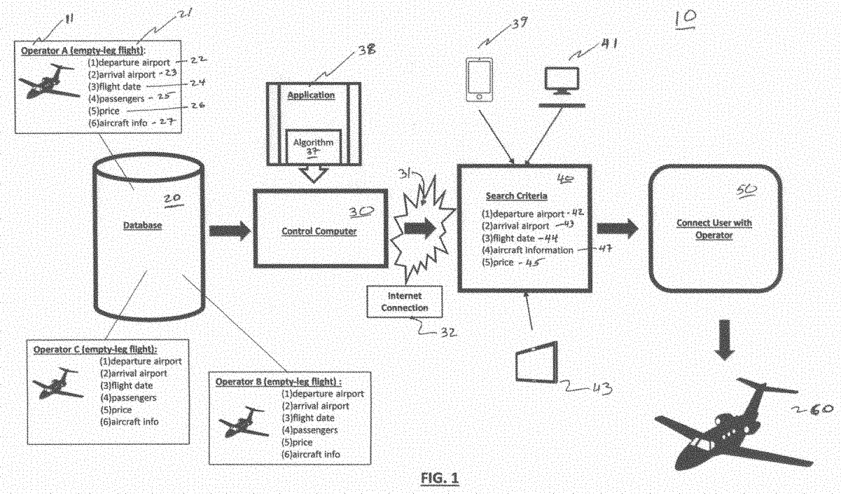

Referring to the figures and more particularly FIG. 1, the system 10 provides a searchable private database 20 that is accessible to the public through the API application 38 of the present invention. The searchable database 20 consists of information provided by private aircraft charter companies or operators 11 relating to empty-leg flights 21. The information relates to the date of the flight 24, the departure airport 22, the destination airport 23, the aircraft information 27, the number of passengers 25, the price 26 and aircraft information. The flight information 27 may include information about the aircraft age, the safety rating of the operator 11, the safety rating of the aircraft 21, the type of aircraft, category of aircraft or other amenities. The information 21-27 is stored in the database 20 and is catalogued according to the date of the flight, the departure airport, the destination airport, the type of the aircraft, the number of passengers, the price and aircraft information.

The searchable database 20 may be searched using a control computer 30 that may be accessed by a user through the internet 31. The computer control 30 utilizes an API or a set of functions and procedures allowing the creation of applications 38 that access the features or data of an operating system, application or other service. The application 38 running on the control computer 30 is the interface that runs the programs and applications of the present invention to search the database 20 and delivers the data from the application to the user over the internet 31. The API conducts the interactions between applications, data and devices to allow for the transmission of data. It provides a way of accessing the data in the database 30 and using it for the purpose described in this invention.

The computer control 30 provides a search engine to connect the user with aircraft charter operators who operate the empty-leg flights 21. The user uses the web access 32 to search and book an empty-leg flight. The aircraft operator 11 may provide information regarding an empty-leg aircraft information 21, departure airport 22, arrival airport 23, flight date 24 number of passengers 25 and price 26 which is entered into the database 20. The aircraft operator 11 may also enter details of the flight 27 which may include information such as amenities, safety record, safety certificates and the like which may be displayed with the aircraft. The aircraft operator 11 may list their empty-leg flights 21 and upload the aircraft, departure airport 22, arrival airport 23, flight date 24, number of passengers 25 and price 26 information pertaining to the empty-leg flights 21 into a database 20. Operators 11 may upload their empty-leg flights 21 and relevant information into the database. The database organizes the information 21-27 into a machine-readable format from the computer control 30. A user using a computer 41, cellphone 39, tablet 43 or any device capable of accessing the internet may log onto the application using a user interface in the form of a website 32 to access the computer control 30. The search criteria page 40 may reside on a web application, website or mobile app. The present invention may permit the operator 11 to remain anonymous to the users during the process of uploading the flight information and display of the flight information so that a user cannot learn the identification of an operator and then avoid the entire look-up process. Likewise, a user's identity remains anonymous so the operator 11 does not learn of the user until a certain flight is selected. Once a passenger books a flight, the identity of the user and operator are disclosed to one another. For example, the user information may be sent only to the operator 11 who then may contact the user. The tail number or other identity information 27 of the empty leg flight 21 is also maintained anonymous on all aircraft 21 displayed to a user.

A control computer 30 interacts with the application 38 running the algorithm program 37 which connects a user with an aircraft operator 11. In the database 20, the aircraft type 21, departure airport 22, arrival airport 23, flight date 24, number of passengers 25 and segment price 26 are all stored in the database 20 in a machine-readable format which is searchable. Control computer 30 hosts an application 38 on which the search algorithm 37 resides. The application 38 supports an API or set of functions and procedures that access the features or data of the database 20. The application 38 contains the search parameters that are used to search the database 20 for the necessary results. In the present invention, the application 38 residing on the control computer 30 requests criteria from the user regarding departure airport 42, arrival airport 43, flight date 44 and number of passengers 45. The user uploads the desired criteria such as departure airport 42, arrival airport 43, flight date 44 and number of passengers 45. The criteria submitted by the user who wishes to purchase or book a flight is converted to a machine-readable format.

The application 38 interacting with the API of the algorithm 37 of the control computer 30 and the API of the database 20 to compare the users requested criteria regarding departure airport 42, arrival airport 43, flight date 44 and number of passengers 45 with the aircraft information 21, departing airport 22, arrival airport 23, flight date 24 and number of passengers 25 that are stored in the database 20. The algorithm 37 of the application 38 conducts a compare sequence to determine the possible matches between the search criteria 42-45 and the information 22-25 with the database 20. If possible, matches exist, the application 38 selects or flags one or more empty leg flights 21 for the user that match the criteria 42-45 set forth by the user based upon a correlation of the criteria 41-44 entered by the user and information 21-25 entered by the operator. The application 38, interacting with the API, may provide each flight information detail with a weight factor such that the departure airport 42, the arrival airport 43, the flight date 44 and the number of passengers 45 would all receive a weight factor. The weight factor could be used to include variations from an exact match to search criteria to fall within the match parameters of the flight information data. For example, if the user enters a departure airport criteria 42 as Chicago O'Hare Airport (ORD) the application 38 would utilize the weight factor assigned to each departure airport 22 information associated with each flight of an operator 11 to flag all flights of an operator 11 that fall within the range of weight factors assigned to the departure airports 22. Thus, all airports within a certain geographic vicinity of O'Hare International Airport will be flagged as a possible match with the departure airport criteria 42. The same weight factor may be applied to the arrival airport 23, flight date 24 and passenger information 25. If each factor, departure airport 22, arrival airport 23, flight date 23 and aircraft information 24 is flagged, the operator 11 flight is selected as a match. The display 30 provides information 21-24 to the user about the empty leg flights 27 that match the user criteria 41-45 and displays the cost for each of the matching flights 46. It is not necessary that each of the criteria for the departure airport 42, the arrival airport 43, flight date 44 or number of passengers 45 be utilized in any search. For example, a user could only enter criteria for the departure airport 42. If the user enters the search without selecting an arrival airport 42, flight date 44 or number of passengers 45, the search criteria for only the departure airport 42 will be compared to the departure airport information 22 in the database 20. All matching operator flights 11 that match the departure airport criteria 42 will be displayed regardless of the arrival airport 43, the flight date 44 or number of passengers 45. Likewise, a user may select only the arrival airport criteria 43, the date 44 or the number of passengers 45 and run the search. The results would show all results for the selected criteria. Finally, any combination of the departure airport 42, arrival airport 43, passengers 44 or other criteria may be selected and all matches for the selected criteria will be displayed.

The user may select any of the matching empty-leg flights 21. At which time, the user is connected 50 to the operator 11 to finalize the details of the trip. Once the details are final, the user engages in the actual flight 60 selected by the user.

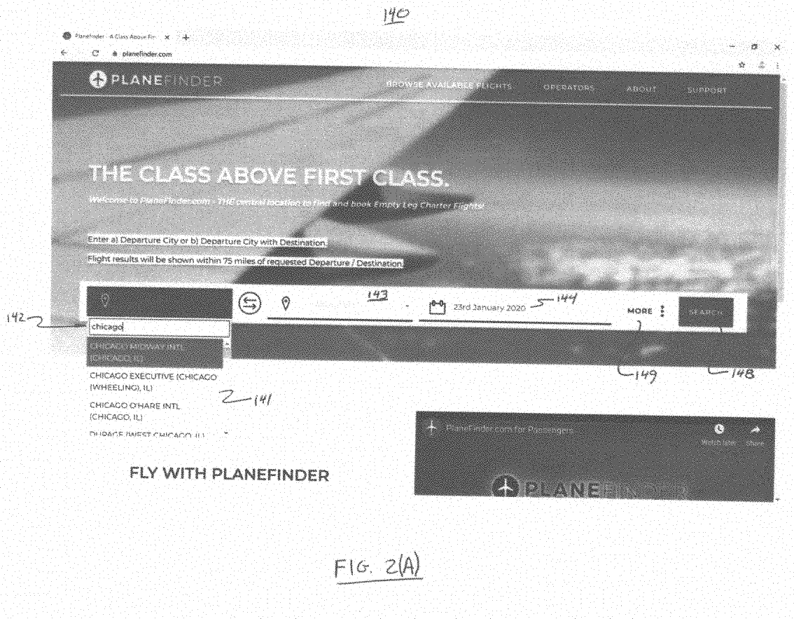

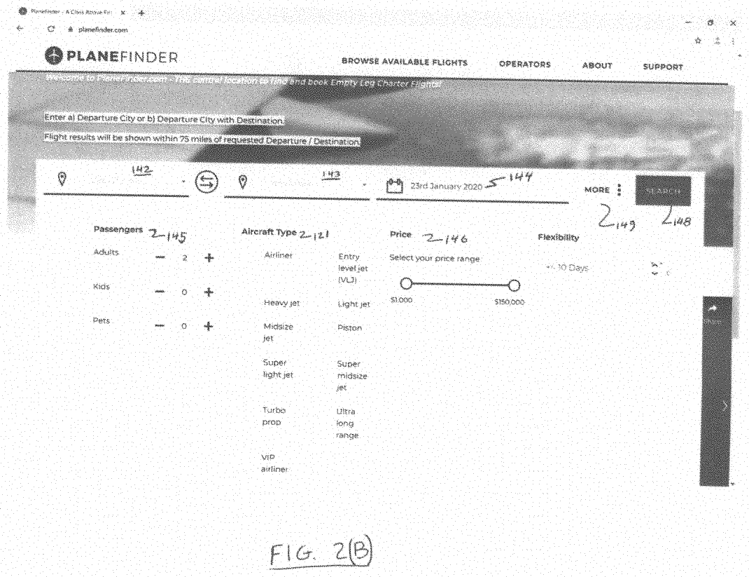

A more detailed description of the present invention can be seen in FIGS. 2(A)-6. FIG. 2(A) shows the display on page 140 of the application or webpage that appears to a user. The display 140 depicts a departure airport box 142 or it may have a pull-down box of departure cities. The departure airport criteria box 142 may include a look-up feature 141. The user may input a predetermined number of letters (such as 3) for a desired city or the user may enter the three-letter airport code for the desired departure airport criteria 42. The departure airport criteria box 142 will show a drop-down box 141 including the airports in, or near, the selected departure city or airport 42. This feature can also be used with the arrival airport criteria box 143. The airport look-up feature makes the process of entering the desired airport easier than typing in the entire name. The look-up feature may reside on a program in the application 38 or in the API of the database 20. The user may click on the departure airport box 142 which will allow for the user to enter the relevant information selected by the user.

The display 140 further depicts an arrival airport box 143 or arrival city. The user may click on the arrival airport box 143 which will allow the user to enter the relevant arrival airport criteria 42 selected by the user. There may be a pull-down box of arrival airport information 143 just as shown for the departure airport box 141. The flight date box 44 is further depicted in the display 140 which, if clicked, permits the user to select the desired flight box 44. FIG. 2(B) shows that there may be other criteria that may be shown on the display in the additional features box 149, such as number of passengers 145, number of children, type of equipment 121 (i.e., entry level jet, heavy jet, light jet, midsize jet, turbo prop, VIP airliner, etc.), price 146, safety certifications and flexibility some of which are not shown in the drawings, but could be shown in the display in the same manner as the departure airport 142, the arrival airport box 143 the flight date box 144 or number of passengers 145. The user may visit the website or application to access the display 140 and fill out the information related to: departure city 42, arrival city 43, date 44, number of passengers 45, pets, aircraft type, safety record, price and flexibility. As a list of criteria is populated, the user can click on the “search” button 148 which submits the selected criteria to the application 38 residing on the control computer 30. The application 38 utilizes an algorithm 37 to conduct a search of the information 21-27 on the database 20. An API coordinates the communication between the application 38 and the database 20.

Referring now to FIG. 1 through 3, the application 38 running the algorithm 37 compares the chosen criteria for the departure airport 42, the arrival airport 43, the date 44 as well as any other selected criteria with information 22-27 submitted from an operation that is stored in the database to determine if there is any matching empty leg flights 21 that correspond with the criteria selected by the user. The application 38 operates to compare the criteria entered by the user using an API for the departing airport 42 with the departing airport information 22 stored in the database 20 of the empty-leg flights 27 submitted by the operators. The application 38 residing on the control computer 30 may also look for departing airport information 22 with a certain preestablished distance from the selected departing airport criteria 42 selected by the user. If a match is found between the departure airport information and departure airport criteria, the match is recognized by the application 38.

Similarly, the algorithm 37 running as part of the application 38 on the control computer 30 operates to compare the criteria entered by the user for the arrival airport 43 with the arrival airport information 23 stored in the database 20 of the empty-leg flights 21 submitted by the operators. The application 38 communicating with the API of the database 20 may also look for arrival airport information 23 with a certain preestablished distance from the selected arrival airport criteria 43 selected by the user. If a match is found between the arrival airport information 23 and airport criteria 43, the match is recognized by the application 38 with a flag. The application 38 further operates to compare the criteria entered by the user for the flight date 44 criteria with the flight date 24 information stored in the database 20 of the empty-leg flights 26 submitted by the operators. The application 38 may also look for flight date information 24 with a certain preestablished range from the selected flight date 44 selected by the user. If a match is found between the departure airport information and departure airport criteria, the match is recognized by the application 38.

The application 38 in which the algorithm 37 resides may also search the database 20 using the API for aircraft information 27 to compare the criteria for the number of passengers 41 selected by the user in the manner described above to determine if there is a match which is then recognized by the application 38 software. The same matching process may be constructed by the application 38 utilizing the algorithm 37 to search for aircraft type, children, pets, flight time or other parameters that may be related to empty-leg charter flights 21 or other criteria that may be applicable which are stored on the API of the database 20.

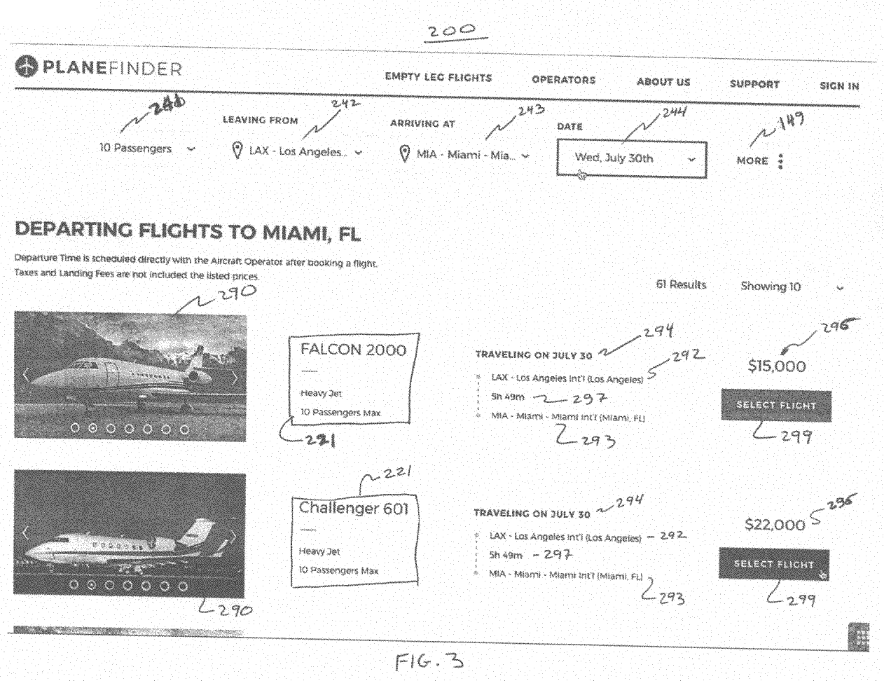

If there are one or more empty-leg flights 21 that match the criteria established by the user, the results are shown in the results display page 200 shown in FIG. 3. On the results display page 200, the criteria information such as the number of passengers 241, the departure airport 242, the arrival airport 243 and the flight date 244 are displayed. The information pertaining to number of passengers 241, the departure airport 242, the arrival airport 243 and flight date 244 displayed by them in the display page 200, may show a range of comparable information that closely relates to the selected criteria submitted by the user. In addition, the flights 221 which match, or closely approximate, the criteria submitted by the user are displayed and a picture of the aircraft 290 is displayed. The matching flights 290 display, the aircraft information and the empty-leg flight 221, along with a picture 290 of the aircraft. In addition, the flight date is displayed 294, as well as, the departure airport 292 (e.g. LAX) and the arrival airport 293 (e.g. MIA). The flight travel time 297 may also be displayed. The price or cost to the user 296 (e.g. $15,000) of the flight is shown in the display 200. A “select flight” box 299 is further displayed 200. A list of results is populated in the display and the user can click on the “select flight” button 299 to review a flight summary of each empty-leg flight 221.

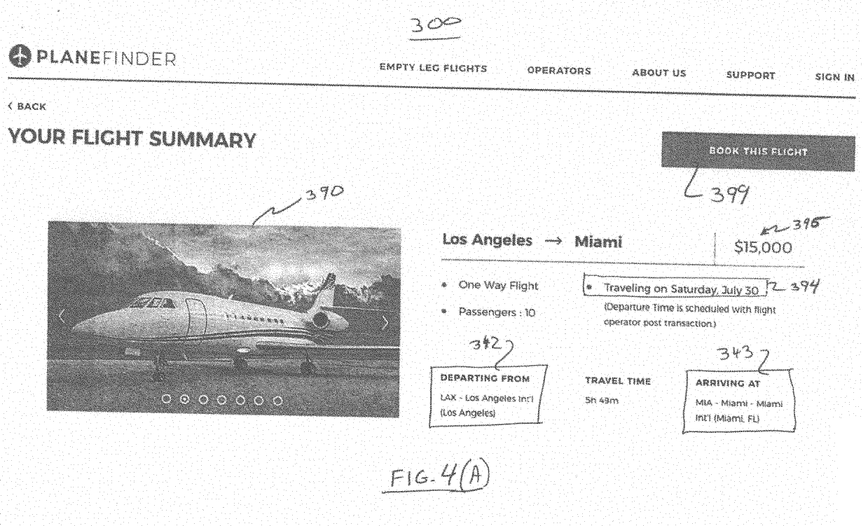

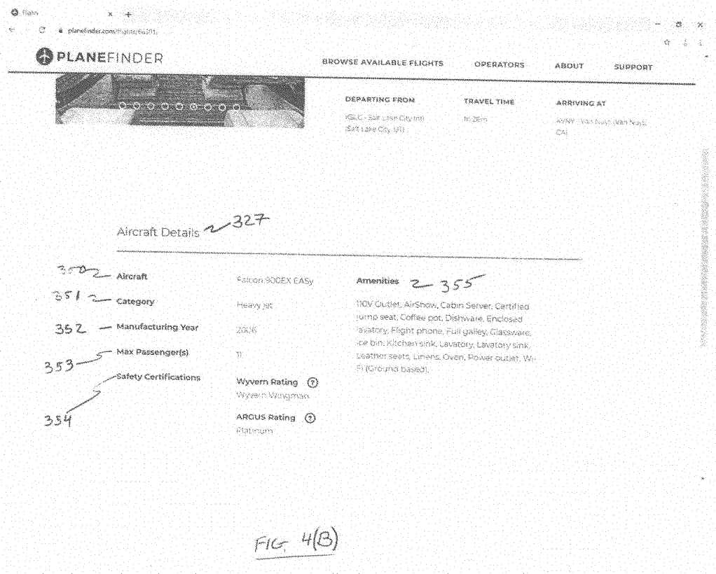

If the user wishes to secure a booking on an empty-leg flight 221, the user will click on the “select flight” button 299, upon which the user will be directed to a flight summary display page 300 as shown in FIGS. 4(A) and 4(B). The flight summary display page 300 shows a picture of the empty-leg aircraft 390. To maintain the anonymity of the operators 11, the picture of the empty-leg aircraft 390 has the tail identification number or aircraft registration number altered to hide any identifying features of the aircraft. The departure airport 342 and arrival airport 343 are also shown. The date 344 is displayed. There is a display for the price of the flight 345. The price may be determined by the aircraft operator or using an auction technique such as a calculated price determined from an aircraft pricing profile in the database 20 or the application 38 of the control computer 30. Other auction techniques include minimum-bid auction or a reverse auction to determine the price 25 for the flight. If the user wishes to secure a booking of the flight, the user can click on the “book this flight” button 399. As shown in FIG. 4(B), the aircraft information 327 is displayed with the type of aircraft 350, the category of aircraft 351, the year of manufacture 352, the number of passengers 353, the safety certificates 354 and the amenities 355.

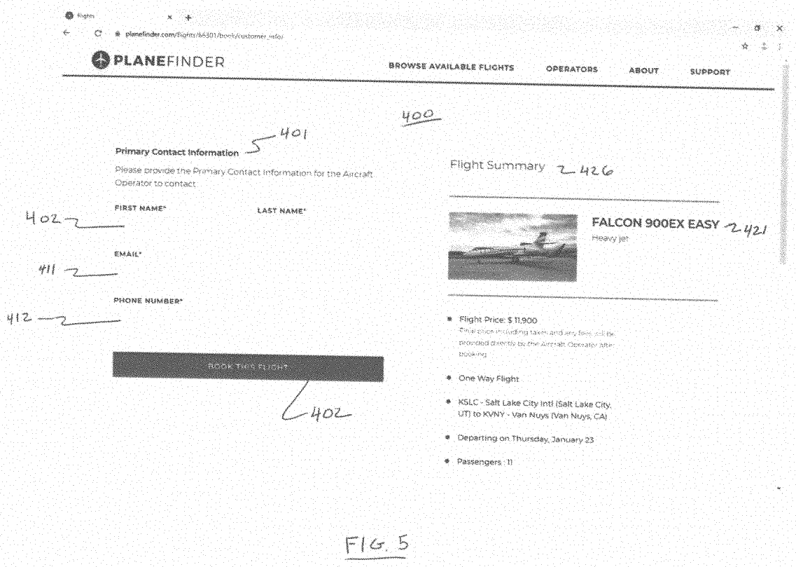

When the “book flight” button 399 is selected, the user is transferred to a customer information 400 page is shown in FIG. 5. The customer information page 400 has an area that displays the user's primary contact information 401 such as name 410, email 411 and phone number 412 which is stored in the application 38 of the control computer 30. The aircraft information 426 may also be displayed.

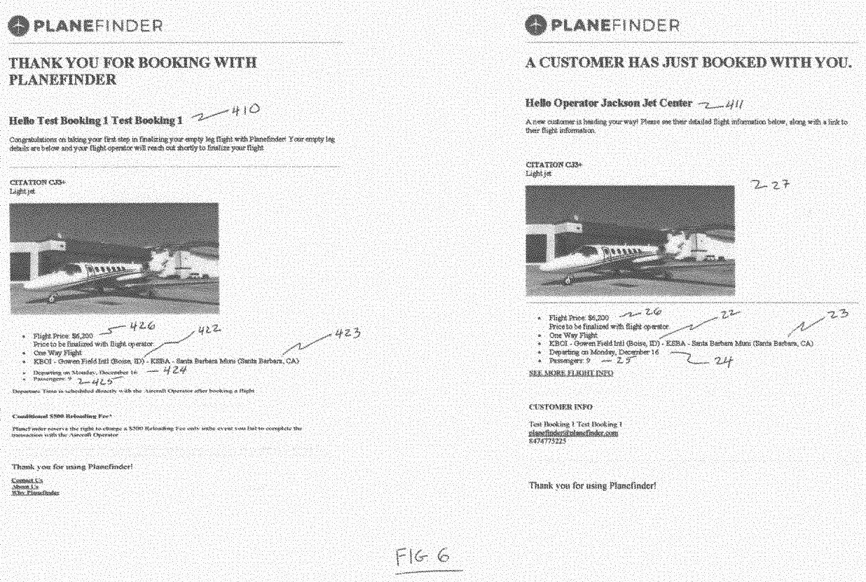

The user may be required to submit payment information 402 in the form of a credit card. While a credit card is one method of payment in the present invention, others forms of electronic payment may be used. In addition, the operation may require that the user pay the operator directly using other payment methods. Once the credit card information 402 has been submitted, the booking process is complete. The confidential information of the user 401 is submitted to the private charter aircraft company 11. It is not until this time that the identity of the aircraft operator 11 and the identity of the user is disclosed to each other. The payment for the flight may be arranged directly through the aircraft operator 11. There may be a credit and payment required to the party that was the control computer 40 and application over the internet 32 in order to verify legitimate bookings. Thus, a booking fee may be charged to the credit card as well as a reloading fee in the event a user fails to actually book the flight 21. Once the book the flight button is selected in FIG. 5, the operator receives an email notification as depicted in FIG. 6. The notification identifies the user 410 to the operator 11 and may (if desired) identify the operator 11 to the user 410 as well. In addition, the flight information such as the price 426/26, the departure airport 422/22, the arrival airport 423/23, the flight date 424/24 and passengers 425/25 are disclosed, along with the aircraft information. The operator 11 will contact the user directly and the two parties will execute a contract for the flight. The customer information page 400 also displays information about the empty-leg flight 421 such as the price 426/26, the departing airport 442, the arrival airport 443 and the departure date 444.

As shown in FIG. 6, the flight request is confirmed. The application will send a confirmation email with an itinerary to the user 410. The operator 11 will also be notified of the flight and will contact the user to finalize the flight details and payment.

It is understood that the invention is not limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for booking a flight comprising the steps of:
uploading into a database, a flight, an aircraft type information, a departure airport, an arrival airport information, a flight date and a price for an empty-leg charter flight;
converting the aircraft type information, the departure airport information, the arrival airport information, the flight date and the cost into a machine-searchable format within the database;
inputting into an application running on a control computer criterion selected by a user for a desired empty-leg charter flight, a departure airport criterion, an arrival airport criterion, and a flight date;
comparing the departure airport criterion with the departure airport information residing in the database using an algorithm in the application to determine if a match occurs, wherein if a match occurs, the aircraft information is flagged for a departure match;
comparing the arrival airport criterion with the arrival airport information residing in the database using an algorithm in the application to determine if a match occurs, wherein if a match occurs, the aircraft information is flagged for an arrival match;
comparing the flight date criterion with the flight date information residing in the database using an algorithm in the application to determine if a match occurs, wherein if a match occurs, the aircraft information is flagged for a departure match;
analyzing the flagged aircraft information using the application on the control computer to determine if the flagged aircraft information corresponds with analyzing the flagged departure match, the flagged arrival match and the flagged flight date;
using the application residing on the control computer to determine if the flagged aircraft information using the application on the control computer to determine if the flagged aircraft information corresponds with analyzing the flagged departure match, the flagged arrival match and the flagged flight date match an aircraft and conveying the aircraft information to the user along with the price for the flight;
selecting the flight;
coordinating payment of the price for the selected flight from the user to the operator; and
conveying the flight information of the selected flight to the user.

2. The method for booking a flight of claim 1 wherein the step of comparing the departure airport criteria further comprising the step of assigning a weight factor to the departure airport information, determining a predetermined range of weight factors for departure airports for flagging the departure match.

3. The method for booking a flight of claim 2 wherein the step of comparing the arrival date criterion further comprising the step of assigning a weight factor to the arrival airport information, determining a predetermined range of weight factors for arrival airports for flagging the departure match.

4. The method for booking a flight of claim 3 wherein the step of comparing the flight date criterion further comprising and determining a predetermined range of flight date for flagging the departure match.

5. The method for booking a flight of claim 1 further comprising:
auctioning the price of an empty-leg charter flight.

6. The method for booking a flight of claim 5 wherein the auction is a minimum bid auction.

7. The method for booking a flight of claim 5 wherein the auction is a reverse auction.

8. The method for booking a flight of claim 1, further comprising the steps of:
uploading into a database the number of passengers with the aircraft type information;
inputting into an application residing on a control computer criterion selected by the user for a number of passengers;
comparing the number of passenger criterion with the number of passenger information residing in the database using the algorithm in the application to determine if a match occurs, wherein if a match occurs the aircraft information is flagged for a passenger match.

9. The method for booking a flight claim 8 wherein the step of comparing the number of passenger criterion further comprising the step of determining a predetermined range of passengers for flagging the passenger match.

10. The method for booking a flight of claim 1 further comprising the step of loading the confidential information of the user and payment information.

11. The method for booking a flight of claim 10 wherein the payment information is a credit card.

12. The method for booking a flight of claim 10 wherein the payment information is a PayPal account.

13. The method for booking a flight of claim 1 wherein the inputting into the application running on the control computer utilizes an API to search a database.

14. The method for booking a flight of claim 1 wherein the inputting into the control computer utilizes an application.

15. A method for booking a flight comprising the steps of:
uploading into a database, information supplied by an operator including an aircraft information, a departure airport, an arrival airport information, a flight date and a price for an empty-leg charter flight wherein the aircraft information and operator are maintained confidential;
converting the aircraft information, the departure airport information, the arrival airport information, the flight date and the cost into a machine-searchable format within the database;
inputting into an application running on a control computer criterion selected by a user for a desired empty-leg charter flight, a departure airport criterion, an arrival airport criterion, and a flight date wherein the user is maintained confidential;
comparing the departure airport criterion with the departure airport information residing in the database using an algorithm in the application on the control computer to determine if the departure airport criterion has been selected by the user and wherein, if a match occurs, the aircraft information is flagged for a departure match and if the departure airport criterion is not selected, all departure airports are flagged;
comparing the arrival airport criterion with the arrival airport information residing in the database using an algorithm in the application running on the control computer to determine if the arrival airport criterion has been selected by the user and wherein, if a match occurs, the aircraft information is flagged for an arrival match and if the arrival airport criterion is not selected, all arrival airports are flagged;
comparing the flight date criterion with the flight date information residing in the database using an algorithm in the application on the control computer to determine if the flight date criterion has been selected by the user and wherein, if a match occurs, the aircraft information is flagged for a departure match and if the flight date criterion is not selected, all flight date are flagged;
analyzing the flagged aircraft information using the application on the control computer to determine if the flagged aircraft information corresponds with analyzing the flagged departure match, the flagged arrival match and the flagged flight date;
using the application on the control computer to determine if the flagged aircraft information using the application on the control computer to determine if the flagged aircraft information corresponds with analyzing the flagged departure match, the flagged arrival match and the flagged flight date match of an aircraft and conveying the aircraft information to the user along with the price for the flight;
selecting the flight;
identifying the confidential user to the operator; and
conveying the flight information of the selected flight to the user and operator.

16. The method for booking a flight of claim 15 further comprising the step of coordinating payment of the price for the selected flight from the user to the operator.

17. The method for booking a flight of claim 15 wherein the step of comparing the departure airport criteria further comprising the step of assigning a weight factor to the departure airport information, determining a predetermined range of weight factors for departure airports for flagging the departure match.

18. The method for booking a flight of claim 17 wherein the step of comparing the arrival date criterion further comprising the step of assigning a weight factor to the arrival airport information, determining a predetermined range of weight factors for arrival airports for flagging the departure match.

19. The method for booking a flight of claim 18 wherein the step of comparing the flight date criterion further comprising and determining a predetermined range of flight date for flagging the departure match.

20. The method for booking a flight of claim 15 further comprising the step of identifying the confidential operator to the user and identifying the confidential user to the operator.
